(19) United States
(12) Patent Application Publication
(10) Pub. No.: US 2023/0143955 A1
(43) Pub. Date: May 11, 2023

(54) STATEFUL CLUTCH SYSTEM AND METHODS

(71) Applicants: Luv Tulsidas, New York, NY (US); Karthikeyan Prakash Kumar, Tamil Nadu (IN); Vivek V, Tamil Nadu (IN)

(72) Inventors: Luv Tulsidas, New York, NY (US); Karthikeyan Prakash Kumar, Tamil Nadu (IN); Vivek V, Tamil Nadu (IN)

(21) Appl. No.: 17/523,585

(22) Filed: Nov. 10, 2021

(51) Int. Cl. F16H 1/20; F16D 28/00

(52) U.S. Cl. CPC F16H 1/206; F16D 28/00

(57) ABSTRACT

The present application provides a stateful clutch system for a DC motor connected with self-locking worm gear. The system includes a first gearbox housing for accommodating a motor coil with a gearbox. Further, the system includes a second gearbox housing for accommodating at least one gear and a driving shaft. Specifically, the gear is adapted for displacing inward and outward movement by establishing a connection with a motor shaft. The driving shaft is adapted for locking and unlocking the gear rotation by transferring and stopping torque. Additionally, the DC motor is used for receiving an input signal from a motor driver for rotating in a clockwise direction and an anticlockwise direction. Moreover, the DC motor rotates in a clockwise direction to disengage connection with the gear moving outward which stops the transfer of the torque through the driving shaft. Furthermore, the DC motor rotates in an anticlockwise direction to engage connection with the gear moving inward by transferring force through the driving shaft.

### TECHNICAL FIELD

The present technology is generally directed to a system for engaging and disengaging power transmission from a drive shaft to a driven shaft, especially for a DC motor with self-locking worm gear. The present technology is generally directed to an electromechanical clutch system.

### BACKGROUND

In self-locking worm gears, electromagnetic (EM) clutches are actuated and the current flows through the electromagnet producing a magnetic field. The rotor portion of the clutch becomes magnetized and sets up a magnetic loop that attracts the armature. The armature is pulled against the rotor and a frictional force is generated at contact. Within a relatively short time, the load is accelerated to match the speed of the rotor, thereby engaging the armature and the output hub of the clutch. In most instances, the rotor is constantly rotating with the input all the time and there is a need for a constant power supply through the process. Contrarily, when current is removed from the clutch, the armature is free to turn with the shaft. In most designs, springs hold the armature away from the rotor surface when power is released, creating a small air gap. However, the process requires a continuous power supply for engaging and disengaging working mechanisms. In various applications, clutches are provided between a steering mechanism which is operated by the driver to steer, and a turning mechanism configured to turn a wheel or a door or a drive or a machine, the clutch being capable of coupling and decoupling the steering mechanism and the turning mechanism.

When a worm gear motor is in a working state by turning power to ON, the EM clutch is engaged. When the worm gear DC motor is in a stop state by turning the power to OFF, the clutch is disengaged. Then, when the worm gear DC motor is stopped by the idle reduction function, the disengaged state of the clutch is maintained. This phenomenon needs a constant power supply to keep the EM clutch in the same state without any disruption. In one instance such as for battery operated devices or robots, EM clutch cannot be used because it will drain the battery completely.

Hence, there is a need for a stateful reliability clutch that can be integrated with any type of worm gear motor and does not require a constant power supply staying in either an engaged state or disengaged state.

### SUMMARY OF THE EMBODIMENTS

The present application provides a stateful clutch system for a DC motor connected with self-locking worm gear. The system comprises a first gearbox housing for accommodating a motor coil with a gearbox. Further, the system includes a second gearbox housing for accommodating a gear and a driving shaft. Specifically, the gear is adapted for displacing inward and outward movement by establishing a connection with a motor shaft. The driving shaft is adapted for locking and unlocking the gear rotation by transferring and stopping torque. Additionally, an electromechanical motor is used for receiving an input signal from a motor driver for rotating in a clockwise direction and an anticlockwise direction. Moreover, the electromechanical motor rotates in a clockwise direction to disengage connection with the gear moving outward which stops the transfer of the torque through the driving shaft.

Furthermore, the electromechanical motor rotates in an anticlockwise direction to engage connection with the gear moving inward by transferring force through the driving shaft. Additionally, the system includes a connecting member for establishing a connection between the motor shaft to the gear. Relevantly, the system also includes a supporting member for reinforcing the driving shaft. The system further includes a circlip having a substantial circular shape being fixed on the gear. Particularly, the DC Motor is an electromechanical motor or an actuator motor or a linear motor or a stepper motor or a servo motor or similar thereof. Moreover, the driving shaft transfers torque to a wheel or conveyor drive or copy machine or any other similar application thereof.

In one aspect, a stateful clutch system is provided that includes: a first gearbox housing and a second gearbox housing coupled to the first gearbox housing for accommodating at least one gear and a drive shaft, wherein the at least one gear is adapted for displacing inward and outward lateral movement therewith establishing a connection with the drive shaft; wherein: the drive shaft is adapted for locking and unlocking a rotation of the at least one gear by transferring and stopping torque; the at least one gear is coupled to a DC motor that receive an input signal from a motor driver for rotating the DC motor in a clockwise direction and an anticlockwise direction, wherein: the DC motor rotates in a clockwise direction for disengaging the at least one gear from the drive shaft therewith stopping transfer of torque through the drive shaft; and the DC motor rotates in an anticlockwise direction for engaging the at least one gear from the drive shaft therewith transferring torque through the drive shaft.

In one embodiment, stateful clutch system includes a connecting member functionally coupled to the DC motor and the at least one gear for establishing a connection between the drive shaft to the at least one gear.

In one embodiment, the connecting member is adapted to accommodate a bearing for facilitating smooth rotation of at least one gear.

In one embodiment, stateful clutch system includes a supporting member coupled to the first gearbox housing over an opening in the housing for supporting a first axle on which the at least one gear rotates and is configured to slide laterally thereon.

In one embodiment, the at least one gear is located on a cylindrical shaft and wherein the cylindrical shaft is configured to move laterally along the axle.

In one embodiment, the drive shaft is fixed against lateral movement.

In one embodiment, when engaged, the at least one gear meshes with a gear fixed on the drive shaft and when disengaged, the at least one gear is moved away from gear fixed on the drive shaft.

In one embodiment, stateful clutch system includes a connecting member having an aperture therein through which the cylindrical shaft passes and connects thereto at a first end of the connecting member, wherein the connecting member connects at a second end opposite the first end to the DC motor and wherein the DC motor causes the cylindrical shaft to move laterally in response to a drive signal.

In one embodiment, the connecting member comprises a pair of tapered halves and wherein the DC motor moves the tapered halves therewith moving the cylindrically shaft laterally.

In one embodiment, a stateful clutch system includes a circlip having a substantial circular shape being fixed on to the at least one gear.

In one embodiment, the DC Motor is at least one of a electromechanical motor, an actuator motor, a linear motor, a stepper motor, a servo motor, or a combination thereof.

In one embodiment, the drive shaft transfers torque to a wheel or conveyor drive or copy machine or any other similar application thereof.

In one aspect, a stateful clutch system is provided that includes: a first gearbox housing; a second gearbox housing coupled to the first gearbox housing for accommodating at least one gear and a drive shaft, the draft shaft against lateral movement; a supporting member coupled to the first gearbox housing over an opening in the housing for supporting a first axle on which the at least one gear rotates and is configured to slide laterally thereon therewith establishing a connection with the drive shaft, wherein: the at least one gear is coupled to a DC motor that receive an input signal from a motor driver for rotating the DC motor in a clockwise direction and an anticlockwise direction, wherein: the DC motor rotates in a clockwise direction for disengaging the at least one gear from the drive shaft therewith stopping transfer of torque through the drive shaft; and the DC motor rotates in an anticlockwise direction for engaging the at least one gear from the drive shaft therewith transferring torque through the drive shaft.

In one embodiment, the stateful clutch includes a connecting member functionally coupled to the DC motor and the at least one gear for establishing a connection between the drive shaft to the at least one gear.

In one embodiment, the stateful clutch includes the connecting member is adapted to accommodate a bearing for facilitating smooth rotation of at least one gear.

In one embodiment, the at least one gear is located on a cylindrical shaft and wherein the cylindrical shaft is configured to move laterally along the axle.

In one embodiment, when engaged, the at least one gear meshes with a gear fixed on the drive shaft and when disengaged, the at least one gear is moved away from gear fixed on the drive shaft.

In one embodiment, the stateful clutch includes a connecting member having an aperture therein through which the cylindrical shaft passes and connects thereto at a first end of the connecting member, wherein the connecting member connects at a second end opposite the first end to the DC motor and wherein the DC motor causes the cylindrical shaft to move laterally in response to a drive signal.

In one embodiment, the connecting member is pivotally coupled to the first gearbox housing, and wherein the DC motor causes the connecting member to pivot therewith moving the cylindrically shaft laterally.

In one embodiment, the connecting member comprises a pair of tapered halves and wherein the DC motor moves the tapered halves therewith moving the cylindrically shaft laterally.

### BRIEF DESCRIPTION OF THE DRAWINGS

For a full understanding of the technology, reference is made to the following detailed description, taken in connection with the accompanying drawings.

FIG. 1 shows a complete assembled front view of a stateful clutch system in accordance with one embodiment disclosed herein;

FIG. 2 shows an exploded view of a stateful clutch system in accordance with another embodiment disclosed herein;

FIG. 3A shows an internal view of a stateful clutch system in disengagement state with another embodiment disclosed herein;

FIG. 3B shows an assembled view of a stateful clutch system in disengagement state with another embodiment disclosed herein;

FIG. 4A shows an internal view of a stateful clutch system in engagement state with another embodiment disclosed herein; and

FIG. 4B shows an assembled view of a stateful clutch system in engagement state with another embodiment disclosed herein.

### DETAILED DESCRIPTION OF EXEMPLARY EMBODIMENTS

The present technology is described in one or more embodiments in the following descriptions with reference to the Figures, in which numerals represent the same. While the technology is described in terms of the best mode for achieving the technology's objectives, it will be appreciated by those skilled in the art that it is intended to cover alternatives, modifications, and equivalents as may be included within the spirit and scope of the technology as defined by the appended claims and their equivalents as supported by the following disclosure and drawings.

All references including patent applications and publications cited herein are incorporated herein by reference in their entirety and for all purposes to the same extent as if each individual publication or patent or patent application was specifically and individually indicated to be incorporated by reference in its entirety for all purposes. Many modifications and variations of this technology can be made without departing from its spirit and scope, as will be apparent to those skilled in the art. The specific embodiments described herein are offered by way of example only. The above specification, examples and data provide a complete description of the manufacture and use of the composition of the technology. Since many embodiments of the technology can be made without departing from the spirit and scope of the technology, the technology resides in the claims hereinafter appended.

While this technology has been particularly shown and described with references to preferred embodiments thereof, it will be understood by those skilled in the art that various changes in form and details may be made therein without departing from the spirit and scope of the technology as defined by the appended claims.

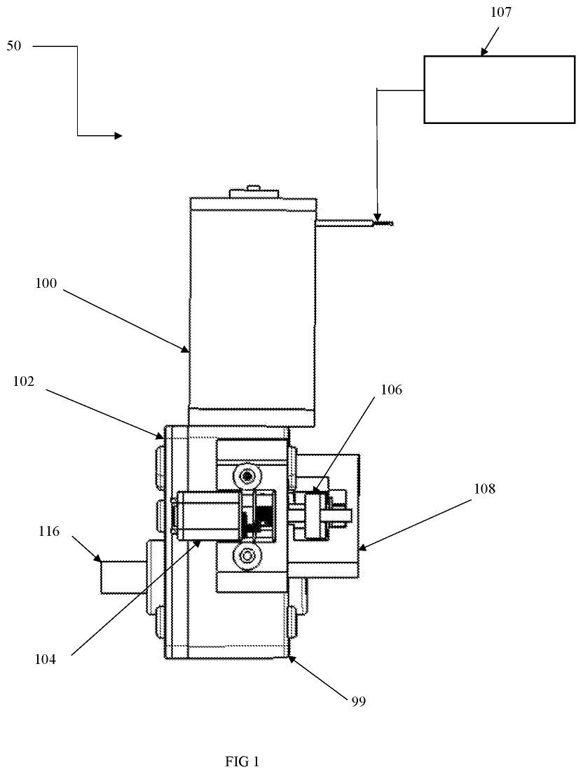

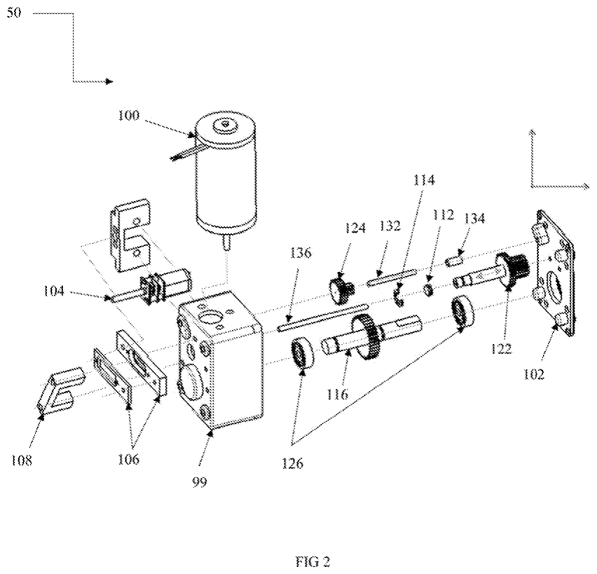

FIG. 1. shows a complete assembled front view of a stateful clutch system 50. Referring to FIG. 1, the stateful clutch 50 includes a first gearbox housing 99, a motor coil housing 100 (coupled to the first gearbox housing 99), and a second gearbox housing 102 (coupled to the first gearbox housing 99). The first and second gearbox housings 99, 102 generally form an enclosure for a gearset that includes a drive shaft 116. The clutch 50 includes an electromechanical device 104 that engages the gearboxes (as shown and described in connection with FIG. 2). The electromechanical device 104 is supported at least partially relative to the first gearbox housing 99 and is functionally connected to a connecting member 106 to cause lateral movement as discussed below. The motor driver 107 provides the drive signal for operating the motor(s) and/or actuators, which engage and/or drive the driveshaft 116 via the gearboxes. The drive shaft 116 generally provides the output from the stateful clutch.

The first gearbox housing 9 9 and/or second gearbox housing 102 receive the motor coil housing 100. The motor coil housing 100 generally includes an electromagnet used to generate a magnetic field in the system 50 consisting of a coil of wire through which a current flows. The electromechanical device 104 works by the magnetic force F=IL×B. The current flows through the motor coil housing 100 such that it points in one direction at one end of the loop and in the other direction at the other end of the loop. The magnetic field at both ends point in the same direction.

The second gearbox housing 102 includes an aperture through which the drive shaft 116 extends. The system 50 actuates electrically but transmits torque mechanically. The system 50 consists of the motor coil housing 100 that is connected to or is part of the first gearbox housing 99, therewith providing an input source and the drive shaft 116 provides the system output. To engage the system 50, the coil in the housing100 is energized, creating a magnetic field, the connector 106 having a pivoting connection which pulls at least one of the gears in the gearboxes and/or the drive shaft 116, establishing a frictional and/or mechanical connection to engage and disengage the motor from the drive shaft 116. The force between the friction surfaces transmits torque from the first gearbox housing 9 9 to the output drive shaft 116. The motor coil housing 100 between both the gearboxes as adapted for displacing inward and outward movement therewith establishing a connection with the drive shaft 116. The drive shaft 116 is adapted for locking and unlocking the gear rotation by transferring and stopping torque.

To disengage the clutch system 50, the electrical power source is shut off. With no magnetic field present, the gearbox associated with the drive shaft 116 is pulled back into its default position. This action creates a small air gap between gearboxes and the drive shaft 116, effectively disengaging the output driving shaft 116 and ceasing torque transmission. Intermittent cycling of the clutch system 50 can also be accomplished by interrupting and re-applying the electrical current at specified intervals.

The electromechanical device 104 receives an input signal from the motor driver 107 for rotating in a clockwise direction and an anticlockwise direction. In addition, the electromechanical device 104 rotates in a clockwise direction for disengaging connection with the gear moving outward to stop transfer of torque through the drive shaft 116. Further, the electromechanical device 104 rotates in an anticlockwise direction for engaging connection with the gear moving inward to transfer torque through the drive shaft 116.

Additionally, a connecting member 106 establishes a connection between the drive shaft 116 to the gearboxes. Particularly, the connecting member 106 is adapted to accommodate a bearing 112 for facilitating smooth rotation thereof. Further, the system includes a supporting member 108 for reinforcing the drive shaft 116.

The electromechanical device 104 receives input from the motor driver 107 and the electromechanical device 104 rotates in a clockwise direction for a specified amount of time. Further, when the electromechanical device 104 rotates in clockwise rotation, the motor's shaft 105 is connected by a connecting member 106 which in turn is connected to the gearboxes. In result, during this event of clockwise rotation the gearboxes will displace or move outward by three millimeters. Therefore, the contact between the gearboxes is disengaged. This disengagement in contact will make the drive shaft 116 as a free wheel rotation.

Contrarily, when the electromechanical device 104 receives an input from the motor driver 107 and the electromechanical device 104 rotates in an anti-clockwise direction for a specified amount of time. Further, while in anti-clockwise rotation, the gearboxes will displace or move inward by three millimeters. In result, during this event the contact between the gearboxes is engaged. This will facilitate the powertrain to transfer the torque through the drive shaft 116 and remove the free wheel motion.

FIG. 2 shows an exploded view of a stateful clutch system 50. Referring to FIG. 2, the clutch system 50 generally includes a first gearbox housing 99, a second gearbox housing 102, an electromechanical device 104, a connecting member 106, a support member 108, gear sets 122, 124, bearings 112 and 126, a circlip 114, one or more axles 132, 136, bushing 134, and a drive shaft 116.

The first gearbox housing 99 may have a generally rectangular box shape, as shown. This housing 99 forms part of the enclosure for the gear sets 122, 124 and the drive shaft 116. The housing 99 also includes a bearing carrier that retains one of the two bearings 126 for the drive shaft 116. The housing 99 may also include a plurality of other recesses (with or without bearings) that support one end of axles 132, 136. The second gearbox housing 102 attaches to the first housing 99 to form a complete enclosure of the gear sets 122, 124. As can be seen, the housing 102 has a bearing carrier that retains the second of the two bearings 126 for the drive shaft 116. In a preferred embodiment, the housing 102 has an opening or aperture, concentric with the bearing 126, through which the drive shaft 116 extends.

The drive shaft 116 has a gear thereon between portions of the shaft that interface with the bearings 126 therewith allowing the drive shaft 116 to rotate within the housings. The drive shaft 116 is preferably fixed against lateral movement (in the direction of the shaft axis). The system 50 includes at least one or a plurality of gearboxes 122, 124. A first gearbox 122 may include a plurality of gears on a cylindrical shaft, as shown. A first axle 136 may be located within the cylindrical shaft of the gearbox 122. The first axle 136 is connected to the second housing 102 at one end and to the support member 108 at the opposite end. In this regard, the first axled is preferably fixed regarding lateral movement. The cylindrical shaft of the gearbox 122, however, is configured to move laterally over the first axle 136, therewith allowing the gearbox 122 to move relative to the gear on the drive shaft 116. This movement, as discussed below, is sufficient to engage and disengage the gearbox 122 from the drive shaft 116 gear. The system 50 may include a second gearbox 124, which similarly rotates on a second axle 132. This gearbox 124 may be fixed laterally with a bushing 134.

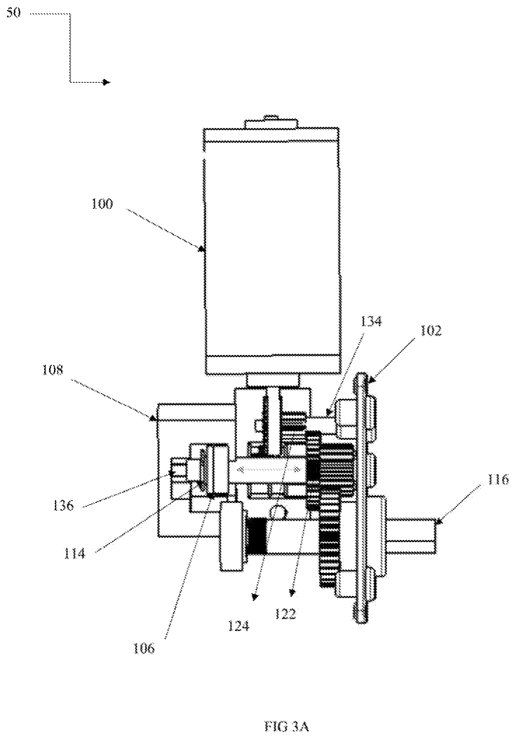

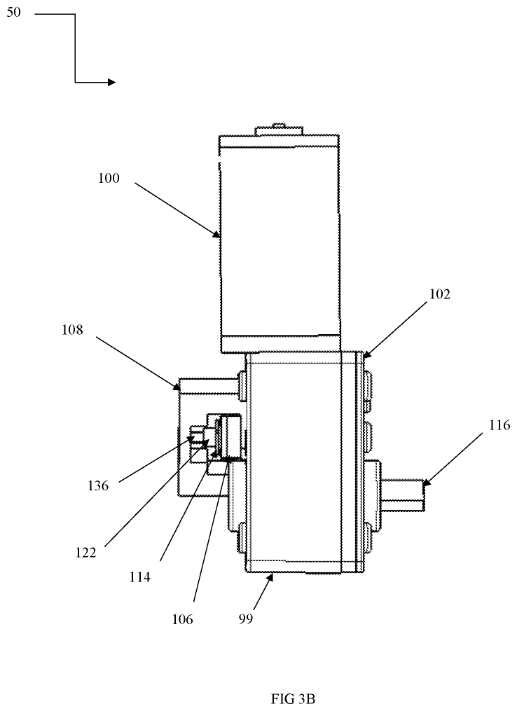

The system 50 may include a connecting member 106. In this embodiment, the connecting member 106 has an aperture or slot therein through which the cylindrical shaft of the gearbox 122 passes and is affixed thereto with circlip 114 (as shown in FIGS. 3A-3B). The connecting member generally causes the gearbox 122 to move laterally. This can be achieved in a variety of ways. In one embodiment, the connecting member 106 is pivotally coupled to the housing 99 such that pivoting of the connector 106 causes the cylindrical shaft of the gearbox 122 to move laterally in and out of the housing 99. In another embodiment, the connecting member 106 includes a plurality of tapered halves that when slid against each other varies the thickness to cause lateral movement in the cylindrical shaft of the gearbox 122. The connector 106 may be coupled to the device 106, such as an actuator, to cause this lateral movement in response to a drive signal from the motor driver 107.

As shown in FIG. 2, the gearboxes 122, 124 to which a rotational torque is input; the system 50 is attached to an inner circumferential face of the gearboxes; the connecting member 106 acts as an engaging element for enabling contact between the first gearbox 122 and the second gearbox 124, which selectively drive the drive shaft 116. The support member 108 holds, for example, the tapered connecting member 106. The drive shaft 116 serves as a driven member for the first gearbox housing 9 9 and the second gearbox housing 102 for sheathing the gearboxes. The system 50 allows a state where the drive shaft 116 is driven by the gearboxes to cause its rotation.

The electromechanical device 104 receives input from the motor driver 107 and the electromechanical device 104 rotates in a clockwise direction for a specified amount of time to cause the connecting member 106 to move laterally. The connecting member 106 is preferably a metal part and facilitates connection between the electromechanical device 104 and the gearboxes. The support member 108 acts as a support for the axle of the intermediate gearbox 122. The gearboxes enable the transmission of torque and the bearings 112 and 126 facilitate smooth rotation. The drive shaft 116 enables the torque transmission to the wheels or conveyors or machines.

Further, when the electromechanical device 104 rotates in clockwise rotation, the drive shaft 116 is connected by a connecting member 106 which in turn is connected to the gearboxes. In result, during this event of clockwise rotation the gearboxes will displace or move outward by, for example, three millimeters. Therefore, the contact between the gearboxes is disengaged. This disengagement in contact will make the drive shaft 116 as a free wheel rotation. Contrarily, when the electromechanical device 104 receives an input from the motor driver 107 and the electromechanical device 104 rotates in an anti-clockwise direction for a specified amount of time. Further, while in anti-clockwise rotation, the gearboxes will displace or move inward, for example, by three millimeters. In result, during this event the contact between the gearboxes is engaged. This will facilitate the powertrain to transfer the torque through the drive shaft 116 and remove the free wheel motion.

FIG. 3A shows an internal view and FIG. 3B shows an assembled view of a stateful clutch system 50 in disengagement state. Referring to FIG. 3A & 3B, includes, inside the system 50, a first gearbox housing 9 9 and a second gearbox housing 102 consisting of gearboxes and a motor driver 107 for transmitting power, a drive shaft 116 for engaging/disengaging transmission of the power of the motor driver 107, a connecting member 106 via bearings 112, an electromechanical device 104 along with a motor coil housing 100 rotatable in unison with the drive shaft 116 for transmission of torque and controlling the power transmission engagement/disengagement of the electromagnetic clutch, and so on.

In operation, when the power of the motor driver 107 is transmitted to the drive shaft 116, the electromechanical device 104 rotates in a clockwise direction for a specified amount of time. On the other hand, when the drive shaft 116 disengages the transmission of the drive power from the motor driver 107, the drive shaft 116 and the gearboxes are rendered freely rotatable relative to torque transmission to a wheel or a conveyor or a machine.

As shown in FIG. 3B, the system 50 includes the motor coil housing 100 meshed with the gearboxes rotatable in operative association with the wheel or conveyor, bearings 112 rotatable, the motor coil housing 100 configured to cause the connecting member 106 to generate a magnetic force which causes the member 106 to be moved along the rotational axis and pulled into contact with each other, and a power supply for supplying electric power to the motor coil 101. In this embodiment, the motor coil housing 100 wound around a bobbin is fixed to the electromechanical device 104, so that the motor coil housing 100 and the drive shaft 116 are rotated in unison.

Further, in system 50, the gearboxes and the bearings 112, 126 are supported to be rotatable relative to the drive shaft 116. On the other hand, the electromechanical device 104 is supported to be rotatable in unison with the drive shaft 116. When power is removed from the system 50, the first gearbox housing 9 9 is free to turn with the drive shaft 116. The connecting member 106 holds the first gearbox housing 9 9 and the second gearbox housing away when power is released, creating the electromechanical device 104 to run clockwise and anti-clockwise directions. At slow speeds, the electromechanical device 104 is so low that the current to the coils in gearboxes is low. Because of that there is not much engagement. Therefore, only low torque can be transmitted.

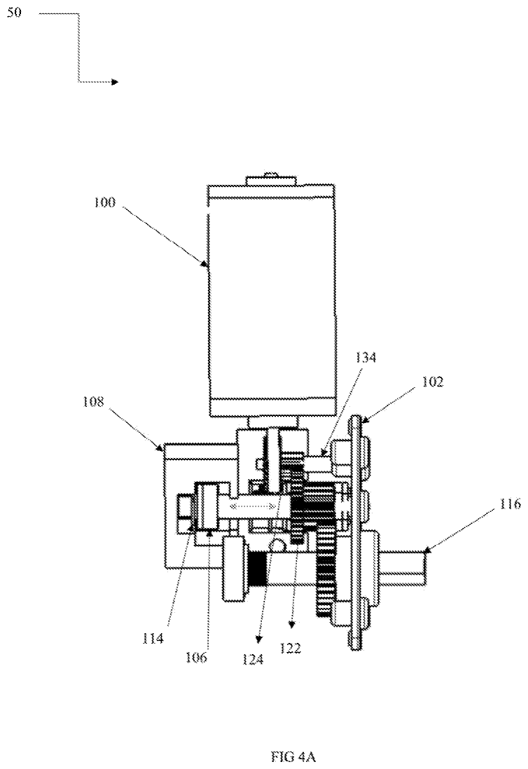

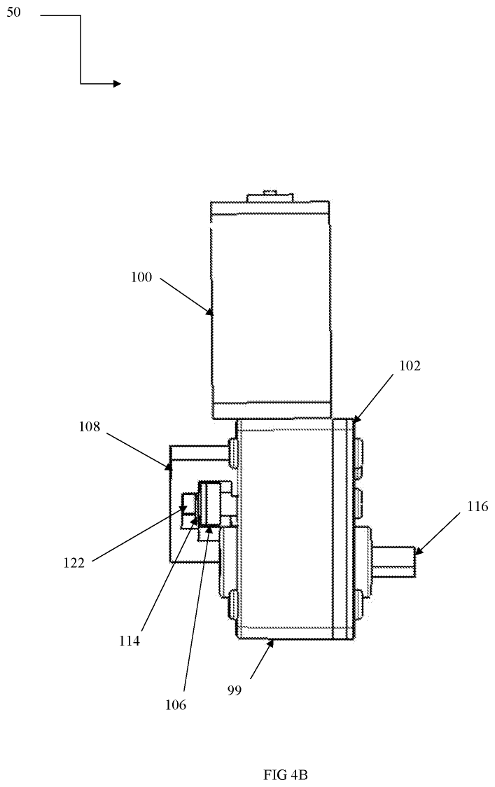

FIG. 4A shows an internal view and FIG. 4B shows an assembled view of a stateful clutch system 50 in engagement state. Referring to FIG. 4A & FIG. 4B, the stateful clutch 50 comprises a first gearbox housing 99, a second gearbox housing 102, connecting member 106, a supporting member 108 and bearings 112.

As shown in FIG. 4A & FIG. 4B, between the first gearbox housing 9 9 and the second gearbox housing 102, there is a connecting member 106 having one side thereof fixed to the second gearbox housing 102 side and the other side thereof slidably contacting the first gearbox housing 9 9 side. In this embodiment, the support member 108 as the connecting member 106 is fixed to the gearboxes which is rotatable together with the first gearbox housing 9 9 and this connecting member 106 slidably contacts the first gearbox housing 99. With this, by the support member 108, the first gearbox housing 9 9 and the second gearbox housing 102 are urged in directions away from each other.

The above-described first gearbox housing 99, the second gearbox housing 102, the connecting member 106 and the power supply have circular annular shapes and are arranged concentrically relative to each other. The first gearbox housing 9 9 is formed of such a material as iron, capable of being attracted by a magnetic force. Further, this first gearbox housing 9 9 includes the gearboxes engageable with the bearings 112 formed accordingly. With this, the first gearbox housing 9 9 is rotatable in operative association with the rotation of the wheel or conveyor and is movable along the axis of the drive shaft 116 closer to/away from the second gearbox housing 102.

Some of the advantages of the present system is firstly, the system can be used in a remote location and in automatic transmission. In addition, the system is fast and easy to operate.

What is claimed is:

1. A stateful clutch system comprising:
a first gearbox housing; and
a second gearbox housing coupled to the first gearbox housing for accommodating at least one gear and a drive shaft, wherein:
the at least one gear is adapted for displacing inward and outward lateral movement therewith establishing a connection with the drive shaft, wherein:
the drive shaft is adapted for locking and unlocking a rotation of the at least one gear by transferring and stopping torque;
the at least one gear is coupled to a DC motor that receive an input signal from a motor driver for rotating the DC motor in a clockwise direction and an anticlockwise direction, wherein:
the DC motor rotates in a clockwise direction for disengaging the at least one gear from the drive shaft therewith stopping transfer of torque through the drive shaft; and
the DC motor rotates in an anticlockwise direction for engaging the at least one gear from the drive shaft therewith transferring torque through the drive shaft.

2. The stateful clutch system of claim 1, further comprising a connecting member functionally coupled to the DC motor and the at least one gear for establishing a connection between the drive shaft to the at least one gear.

3. The stateful clutch system of claim 2, wherein the connecting member is adapted to accommodate a bearing for facilitating smooth rotation of at least one gear.

4. The stateful clutch system of claim 1, further comprising a supporting member coupled to the first gearbox housing over an opening in the housing for supporting a first axle on which the at least one gear rotates and is configured to slide laterally thereon.

5. The stateful clutch system of claim 4, wherein the at least one gear is located on a cylindrical shaft and wherein the cylindrical shaft is configured to move laterally along the axle.

6. The stateful clutch system of claim 5, wherein the drive shaft is fixed against lateral movement.

7. The stateful clutch system of claim 6, wherein when engaged, the at least one gear meshes with a gear fixed on the drive shaft and when disengaged, the at least one gear is moved away from gear fixed on the drive shaft.

8. The stateful clutch system of claim 6, comprising a connecting member having an aperture therein through which the cylindrical shaft passes and connects thereto at a first end of the connecting member, wherein the connecting member connects at a second end opposite the first end to the DC motor and wherein the DC motor causes the cylindrical shaft to move laterally in response to a drive signal.

9. The stateful clutch system of claim 8, wherein the connecting member comprises a pair of tapered halves and wherein the DC motor moves the tapered halves therewith moving the cylindrically shaft laterally.

10. The stateful clutch of system claim 1, further comprising a circlip having a substantial circular shape being fixed on to the at least one gear.

11. The stateful clutch of system claim 1, wherein the DC Motor is at least one of a electromechanical motor, an actuator motor, a linear motor, a stepper motor, a servo motor, or a combination thereof.

12. The stateful clutch of system claim 1, wherein the drive shaft transfers torque to a wheel or conveyor drive or copy machine or any other similar application thereof.

13. A stateful clutch system comprising:
a first gearbox housing;
a second gearbox housing coupled to the first gearbox housing for accommodating at least one gear and a drive shaft, the draft shaft against lateral movement; and
a supporting member coupled to the first gearbox housing over an opening in the housing for supporting a first axle on which the at least one gear rotates and is configured to slide laterally thereon therewith establishing a connection with the drive shaft, wherein:
the at least one gear is coupled to a DC motor that receive an input signal from a motor driver for rotating the DC motor in a clockwise direction and an anticlockwise direction, wherein:
the DC motor rotates in a clockwise direction for disengaging the at least one gear from the drive shaft therewith stopping transfer of torque through the drive shaft; and
the DC motor rotates in an anticlockwise direction for engaging the at least one gear from the drive shaft therewith transferring torque through the drive shaft.

14. The stateful clutch system of claim 13, further comprising a connecting member functionally coupled to the DC motor and the at least one gear for establishing a connection between the drive shaft to the at least one gear.

15. The stateful clutch system of claim 14, wherein the connecting member is adapted to accommodate a bearing for facilitating smooth rotation of the at least one gear.

16. The stateful clutch system of claim 15, wherein the at least one gear is located on a cylindrical shaft and wherein the cylindrical shaft is configured to move laterally along the axle.

17. The stateful clutch system of claim 16, wherein when engaged, the at least one gear meshes with a gear fixed on the drive shaft and when disengaged, the at least one gear is moved away from gear fixed on the drive shaft.

18. The stateful clutch system of claim 16, comprising a connecting member having an aperture therein through which the cylindrical shaft passes and connects thereto at a first end of the connecting member, wherein the connecting member connects at a second end opposite the first end to the DC motor and wherein the DC motor causes the cylindrical shaft to move laterally in response to a drive signal.

19. The stateful clutch system of claim 18, wherein the connecting member is pivotally coupled to the first gearbox housing, and wherein the DC motor causes the connecting member to pivot therewith moving the cylindrically shaft laterally.

20. The stateful clutch system of claim 14, wherein the connecting member comprises a pair of tapered halves and wherein the DC motor moves the tapered halves therewith moving the cylindrically shaft laterally.
